(19) United States
(12) Patent Application Publication
(10) Pub. No.: US 2023/0047737 A1
(43) Pub. Date: Feb. 16, 2023

(54) BICYCLE CUSHION AND SUPPORT APPARATUS

(71) Applicant: Christian Echavarria, Sewickley, PA (US)

(72) Inventor: Christian Echavarria, Sewickley, PA (US)

(21) Appl. No.: 17/445,016

(22) Filed: Aug. 13, 2021

(51) Int. Cl. B62J 1/00; B62J 1/26

(52) U.S. Cl. CPC B62J 1/007; B62J 1/005; B62J 1/26

(57) ABSTRACT

Apparatuses, systems, and methods of providing support to a pelvis of a user are disclosed herein. Specifically, a cushioning and support apparatus is provided in separable sections that can be selectively positioned on a bicycle saddle. Both sections are provided with multiple protrusions and an opening in a central portion thereof to provide support to the ischium bones of the user. Both sections are designed to be positioned based a widest portion of the bicycle saddle and the sitting bone width of the user.

### BACKGROUND OF THE INVENTION

The present invention relates to bicycle saddles and, more particularly, to a support and cushioning apparatus for bicycle saddles.

When individuals ride bicycles (e.g., road bicycle, off road bicycle or mountain bicycle), regardless of the saddle shape, riding style, bike fit or pelvis anatomy, the full body weight is rested on two small bones, called the ischium bones. Similarly, when individuals ride bicycles in an aerodynamic position (e.g., road bicycle, Time-Trial (TT) bicycle, triathlon bicycle), regardless of the saddle shape, riding style, bike fit or pelvis anatomy, the full body weight rests on two small bones called the pubic bones. Riding of bicycles in any posture requires the riders to maintain the posture throughout the riding, which leads to continuous resting of their full body weight on the ischium bones and tissues under those ischium bones. Riding the bicycle, particularly, in the aerodynamic position tends to rest the full body weight of the rider on the pubis bones and tissue under the pubis bones, which, inter alia, creates concentrated saddle pressure and contact in a small, narrow area of the buttocks.

Accordingly, concentrated saddle pressure and contact in a small, narrow area of our buttocks has a number of negative consequences, including: reduction of performance due to micro-sliding on the saddle, buildup of tenderness and discomfort during long rides, and limiting of blood circulation. This can further lead to painful saddle sores which may initially develop as skin abrasion, then folliculitis (which looks like a small, reddish acne), and finally abscess, which is extremely dangerous and may cause serious infection in human body.

Riders who ride a bicycle in the aerodynamic position, which is a usual posture while riding, for example, road bicycles, Time-Trial (TT) bicycles, and triathlon bicycles, causes concentrated saddle pressure and contact in a small, narrow area of rider's buttocks. This builds tenderness and discomfort during long rides and compromises maintaining the optimal aero position for extended periods of time and reduces performance of the biker due to micro-sliding on the saddle during the pedal motions.

One traditional approach to attempt to resolve these problems is to add more padding to the saddle, either by having it built into the saddle or provided as additional cushion to the saddle; however, this creates more discomfort to biker. It increases the overall height of the bike, and it does not work as a problem solver but, rather, results in more problems. The full body weight will sink down on the ischium bones or the pubis bones to a point where the body weight is again creating a concentrated saddle pressure and contact in a small, narrow area of the buttocks, which can lead to all of the above-described health problems related to concentrated saddle pressure. In the case where a biker rides in the aerodynamic position, like discussed above, there is a resultant buildup of tenderness and discomfort during long rides, compromising the maintaining of an optimal aero position for extended periods of time and reducing performance due to micro-sliding on the saddle during the pedal motion.

As can be seen, there is a need for an apparatus that is designed to increase the contact area and cradle, wedge the ischium bones on the saddle to reduce micro-sliding, prevent saddle sores and provide comfort during long rides. For riders who ride a bicycle (e.g., road bicycle, TT bicycle, triathlon bicycle) in the aerodynamic position, the apparatus of the present invention is designed to add the comfortable support of the ischium bones to the support provided by the pubis bones in the aerodynamic position which create a larger, more comfortable contact area that eliminates micro-sliding, anchors the optimal body position, allows longer times in the aerodynamic position, and provides for comfort during long rides.

### SUMMARY OF THE INVENTION

One embodiment of the present invention is a soft material apparatus for safety of bicycle riders designed to cradle and wedge the ischium bones of the human hip in the sitting position in a bicycle where the full weight of the body is resting on the ischium bones and the thin tissue directly under the ischium bones or where the full body weight is resting on the pubis bones and the thin tissue directly under such bones. The apparatus is designed to be integrated inside the bicycle saddle, attached to the surface of the bicycle saddle or even integrated inside the padding of bicycle shorts or pants.

For riders who ride a bicycle (e.g., road bicycle, off road bicycle or mountain bicycle), this apparatus is designed to increase the contact area and cradle, wedge the ischium bones on the saddle to reduce micro-sliding, prevent saddle sores and infection caused by the saddle sores and provide comfort during long rides. The riders who ride a bicycle (e.g., road bicycle, TT bicycle, triathlon bicycle) in the aerodynamic position, this apparatus is designed to add the support of the ischium bones to the support provided by the pubis bones in the aerodynamic position to create a larger, more comfortable contact area that eliminates micro-sliding, anchors the optimal body position, and allows longer times in the aero position, and provide comfort during long rides.

The claimed invention differs from what currently exists. There is no other solution in the field that is designed to cradle, wedge the ischium bones to increase the contact area and cradle, wedge the ischium bones on the saddle to reduce micro-sliding, prevent saddle sores and provide comfort during long rides. There is no other solution in the field that, for a cyclist in the aerodynamic position, is designed to add the support of the ischium bones to the support provided by the pubis bones in the aerodynamic position to create a larger, more comfortable contact area that eliminates micro-sliding, anchors the cyclist's optimal body position, allows longer times in the aero position, and provides comfort during long rides.

The present invention is an improvement on what currently exists. There are no other solutions in the in the field that are design to cradle, wedge the ischium bones or designed to add the support of the ischium bones to the support provided by the pubis bones in the aerodynamic position to improve performance and comfort for bicycle riders. As mentioned above, the only previous approach has been to add more padding to the saddle or adding more padding to biking shorts and pants on the buttock area around the ischium and pubis. Further, the solution described herein is specifically designed to detach into separate sections in order to provide individualized, customizable support for the user it is intended for. Methods in accordance with the present invention are disclosed that facilitate maximum support and maximum improved performance for the cyclist.

These traditional approaches do not work, as discussed above. The full body weight will sink down the ischium bones or the pubis bones to a point where the body weight is again creating a concentrated saddle pressure and contact in a small, narrow area of the buttocks, which leads to tenderness and discomfort during long rides, and limit circulation, leading to painful saddle sores. In the case of the aerodynamic position, it builds tenderness and discomfort during long rides, compromises maintaining the optimal aero position for extended periods of time and reduces performance due to micro-sliding on the saddle during the pedal motion.

The foregoing descriptions outline some pertinent features and objects of the present invention. These may be illustrative of more exhaustive and comprehensive features described later in the application. The technical terms used in this document, are meant with the same meaning as understood by a typical expert of the field which is related to the invention. These and other features, aspects and advantages of the present invention will become better understood with reference to the following drawings, description and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of a first embodiment of the present invention, shown in use with a bicycle saddle in phantom lines;

FIG. 2 is a top plan view of the first embodiment of the present invention;

FIG. 3 is a front elevation view of the first embodiment of the present invention;

FIG. 4 is a side elevation view of the first embodiment of the present invention, with a cyclist's pelvis shown in phantom lines;

FIG. 5 is a perspective view of a first embodiment of the present invention, shown in use with a bicycle saddle in phantom lines;

FIG. 6 is a top plan view of the first embodiment of the present invention;

FIG. 7 is a front elevation view of the first embodiment of the present invention; and

FIG. 8 is a side elevation view of the first embodiment of the present invention, with a cyclist's pelvis shown in phantom lines;

FIG. 9 is a schematic diagram illustrating a step of fitting the first embodiment of the present invention to the bicycle saddle;

FIG. 10 is a schematic diagram illustrating another step of fitting the first embodiment of the present invention to the bicycle saddle; and

FIG. 11 is a flow chart of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, one embodiment of the present invention is a bicycle saddle cushion and support apparatus for a user. It is provided in separable sections, both of which being selectively positionable on the bicycle saddle. Both sections are provided with multiple protrusions and an opening in a central portion thereof to provide support to the ischium bones of the user. Both sections are designed to be positioned based a widest portion of the bicycle saddle and the sitting bone width of the user.

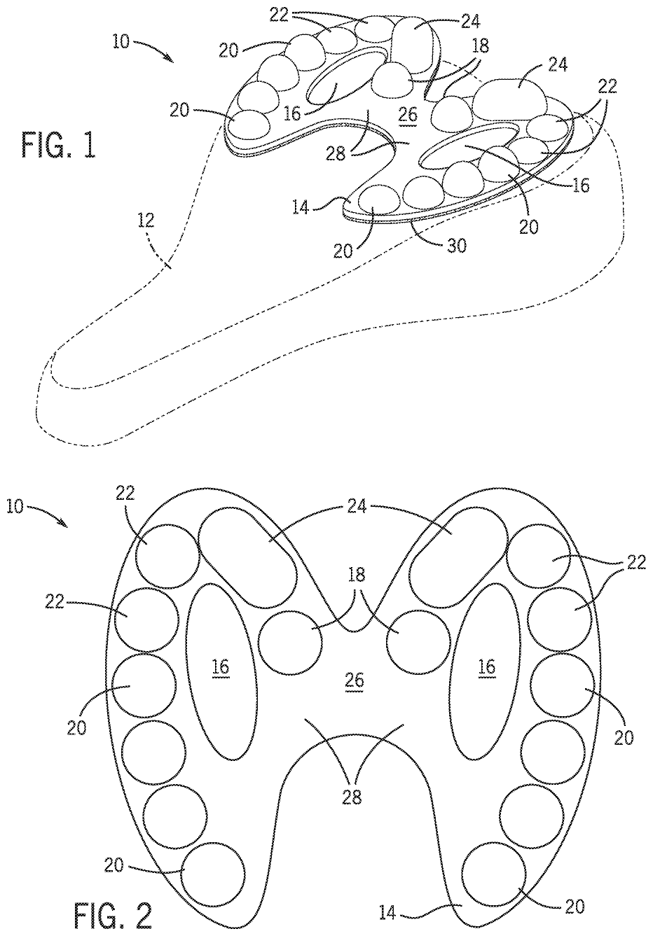

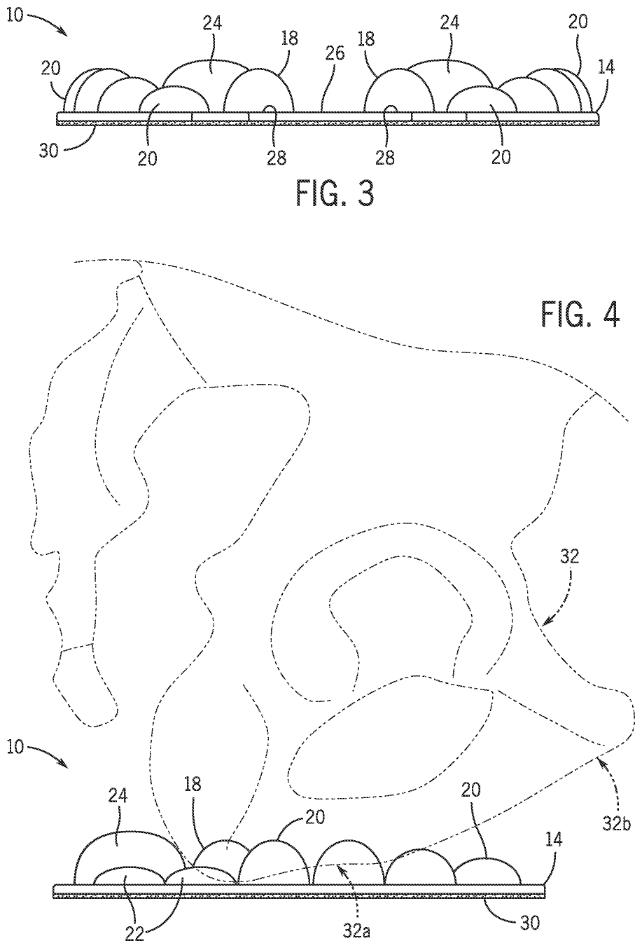

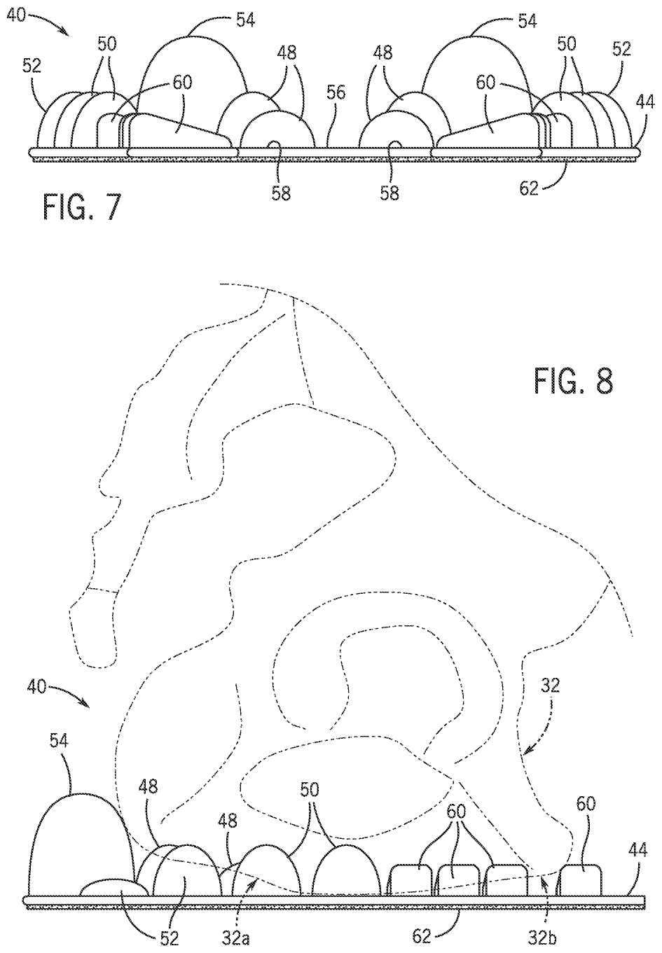

Referring now to FIGS. 1-8, two exemplary embodiments of the present invention are described herein. These embodiments are used to demonstrate the core concepts of the present invention and are not intended to limit the scope of the present invention, except as otherwise defined in the appended claims.

Referring specifically to FIGS. 1-4, an embodiment of a road bicycle saddle cushion and support apparatus 10 (also used interchangeably with road saddle apparatus) is disclosed. This embodiment is designed for use with, for example, a road cycling bicycle, an off road bicycle or a mountain bicycle that includes a road cycling bicycle saddle 12. The road saddle apparatus 10 may be molded as a single unit, with each component having a specific function, as detailed further below. The road saddle apparatus includes a base 14, which functions, in part, to define a general shape of the apparatus 10, and forms a substantially planar bottom surface for holding a self-adhesive 30 (which covers the entire bottom surface). The base 14, in combination with the self-adhesive 30, retains the overall road saddle apparatus 10 securely in place on the saddle 12 as a rider puts significant sheer pressure thereon (between the apparatus 10 and the saddle 12) during pedal motion.

The base 14 has two distinct sections (see left and right sides of FIG. 2), which are partially circular shape, and each define a base depression 16 in a center portion thereof. Due to the anatomy of the ischium 32a of a pelvis 32, this base depression 16 (provided as a perforation/opening) is designed to accommodate the typical under surface of the ischium 32a where it makes contact (through a thin layer of body tissue) with the saddle 12. As shown, a length of the semi-major axis of the base depression 16 may be approximately 1.4 inches, and is designed to balance comfort, stability, and the ability to move back and forth on the saddle and ensure that riders do not pinch any nerves nor obstruct circulation.

Each section further includes a plurality of protrusions 18, 20, 22, 24 (all formed of a cushioning material) for providing unique support for specific sections of a cyclist's buttocks. As shown in FIG. 1, an ischium inner cradle protrusion 18 is provided on an inner side of each section and is partially cylindrical in shape. This protrusion 18 is molded onto the base 14 and is designed to support the tissue that attaches to the ischium 32a on the inner part of the buttocks of the cyclist. Each protrusion 18 is disposed proximal an alignment bridge 26, which will be described in greater detail below.

On each front-to-middle outer portions of the apparatus 10 are provided a plurality of ischium outer cradle protrusions 20 (which form, in essence, a non-continuous wall of support), which are also molded onto the base 14. As shown in FIG. 4, these protrusions 20 may be tapered in height from back to front of the apparatus 10 (for example, from 0.3125 inches to 0.1875 inches) and are designed to support the tissue that attaches to the ischium 32a on the outer parts of the buttocks. The tapering is important because it allows intentional forward and back movement on the saddle. For example, a rider may decide to move forward on the saddle to climb.

On outer rear portions of each section of the apparatus 10 are reduced height protrusions 22 which effectively form an ischium cradle channel. This channel is a gap in the ischium outer cradle protrusions 20 engineered to allow the anatomy of the ischium 32a to settle onto the wall of support defined by the ischium outer cradle protrusions 20. Specifically, the reduced height protrusions are designed to directly support a widest point of the user's ischium 32a, and the method of ensuring that is the case is described in greater detail below.

Making further reference to FIGS. 1-4, each section further includes an ischium cradle backstop 24, which is generally an elongated protrusion relative to the previously described protrusions. These backstops 24 work in conjunction with the ischium outer cradle protrusions 20 and ischium inner cradle protrusions to provide a complete cradling of the ischium 32a and serve as a rear side support to provide better stability for the buttocks during the pedaling motion. By way of example, when a cyclist/rider is pedaling, they start the pedal cycle by applying a forward force to the pedal starting at 12 o'clock. This forward force will have a equivalent backward push. The backstop 24 is designed to stabilize the back push, and may be dimensioned with a height of, for example, 0.3750 inches.

On inner sides of each section is ischium inner padding 28. The padding 28 is provided proximal the ischium inner cradle protrusion 18, as shown in FIG. 2. This padding 28 provides cushioning when the rider is in the aerodynamic position on the bicycle and the weight of the rider is resting on both the ischium 32a and the pubis 32b bones and the tissue under such bones.

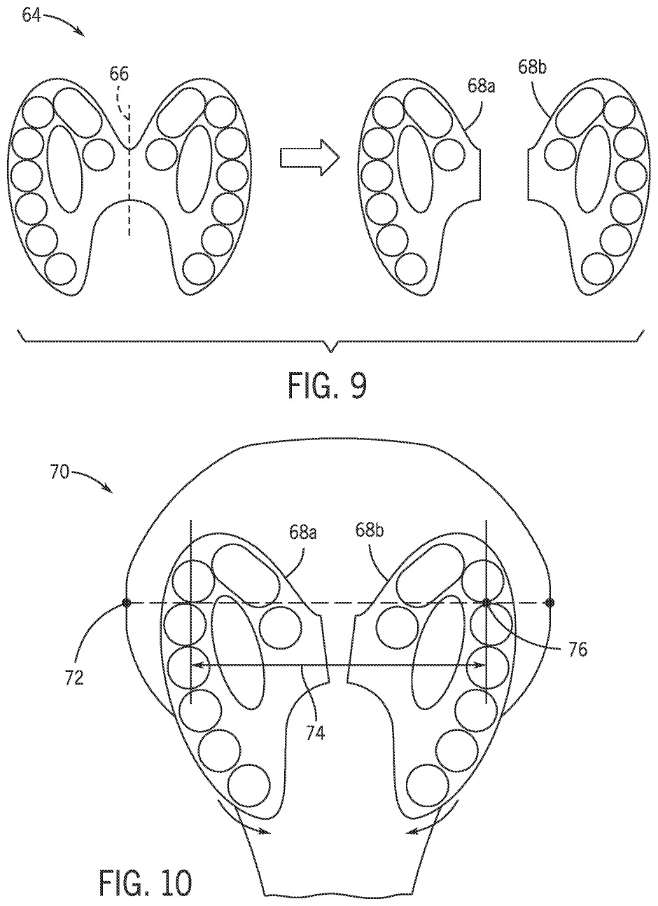

Connecting the two aforementioned left and right sections of the apparatus 10 is an alignment bridge 26, as shown in FIG. 2. The alignment bridge is design to ensure that the angle and spacing of the two sections is properly sized for a range of typical ischium 32a anatomy differences (typically between 100 millimeters and 150 millimeters). The alignment bridge 26 is also designed to allow for adjustment of spacing between the left and right sections to account for unusual ischium 32a sizes or angles. To adjust the spacing of the sections, the alignment bridge 26 may be cut down the middle to separate the sections and attach them separately to the saddle 12, as explained in greater detail below. It will be appreciated that the apparatus 10 may also be embodied as separate left and right sections from the point of manufacture (such as the configuration shown on the right side of FIG. 9), rather than being formed as a single integral piece that is then separated.

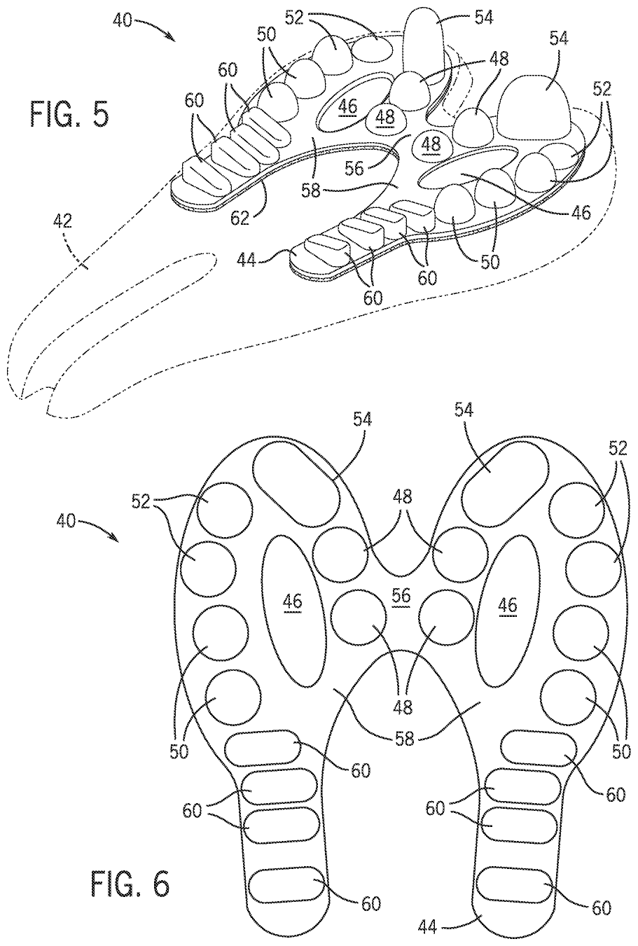

Making reference now to FIGS. 5-8, a second embodiment of the present invention is disclosed. This embodiment is generally referred to as a time trial cycling apparatus 40. This apparatus 40 may include a bicycle saddle 42, a base 44, base depressions 46, ischium inner cradle protrusions 48, ischium outer cradle protrusions 50, ischium cradle channels 52, ischium cradle backstops 54, an alignment bridge 56, ischium inner padding 58, and an adhesive 62, which, as will be appreciated by those with skill in the art, essentially corresponds in structure and function as the first embodiment 10. Due to the similarities in both embodiments, only particular attention is paid to differences in how the designs are embodied to educate those with skill in the art how the present invention may be applied in other forms for different forms of cycling.

In particular, as shown in FIG. 6, the base 44, relative to the first embodiment 10, is elongated at a lower portion thereof. This elongated portion includes pubis aero padding 60 on both the left and right sides of the apparatus 40 for additional support. This padding 60, similar to the first embodiment 10, is lower in height than the ischium outer cradle walls 50 to provide a tapered effect. It provides additional support/padding when the rider is in the aerodynamic position on the saddle 42, and the weight of the rider is resting on both the ischium 32a and the pelvis 32b and the tissue under such bones. As shown in FIG. 8, the backstops 54 may be significantly taller than other protrusions of the apparatus 40. For example, the backstops 48 may be approximately 0.75 inches tall, whereas the ischium outer cradle walls 50 may be approximately 0.375 inches tall.

As will be appreciated by those with skill in the art from the foregoing, both embodiments of the present invention function to achieve similar ends. In simple terms, the apparatuses 10, 40 are designed to increase the contact area, cradle, and wedge the ischium 32a bones on the saddles 12, 42 to increase performance (i.e., eliminate micro-sliding and vibration) during the pedal motion and provide comfort during long rides.

In preferred embodiments, the apparatuses 10, 40 should be molded as a single piece use material with a hardness range of 5-20 Durometer in the Shore A scale to achieve the right balance between support, deformation, and cradle/wedging performance. While the embodiments described herein offer superior configurability for each individual cyclist, the apparatuses 10, 40 may also be built as an insert under the saddle surface or be embodied as an attachment to the cycling shorts of a bicycle rider to provide the aforementioned ischium support.

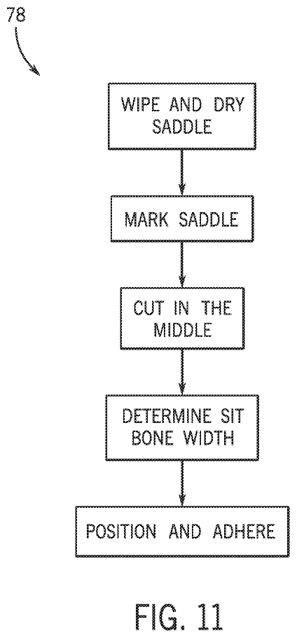

Reference is now made to FIGS. 9-11, which illustrate an exemplary method of installing the road saddle apparatus 10 on a saddle 12. Methods of fitting and installing the road saddle apparatus 10 and the time trial saddle apparatus 40 are substantially the same, except as noted below. In general, a separating step 64 is shown in FIG. 9, a placement step 70 is shown in FIG. 10, and a flow chart 78 summarizing the method is shown in FIG. 11.

More specifically, first, the saddle 12, 42 is wiped dry of moisture and oils to ensure it will get good adhesion. Second, the position on the saddle to place the apparatus is established and a small marking is made on the saddle for such placement. As part of this step, a user may locate the widest point 72 on their saddle and draw a line (or make a few dots) with a writing utensil (such as a felt pen) between those two points. This is generally denoted by the dashed line in FIG. 10. Then the user may draw a small line to mark the center of the saddle. Third, and as shown in FIG. 9, the apparatus 10, 40 is cut down the middle 66 (via, for example, a cutting line) through the alignment bridge 26, 56 to divide the left section 68a and the right section 68b.

Fourth, the sit bone (i.e., ischium 32a) width 74 is determined. This can be done by a couple of methods. One approach is to estimate the sit bone width 74 based upon biking short size. For example, a men's extra small size may correspond to a 90 millimeter (mm) sit bone width, whereas a men's size small may correspond to a 100 mm sit bone width, etc. Another approach is to physically measure the sit bone width 74 in the following manner. Undulated heavy paper may be provided in a kit, which can be sat on by the user, with the undulation facing up. The user, after sitting on it, may do a small “butt hop” to create bone markings on the undulations, and the distance between the two small centers may then be measured (this distance being the sit bone width 74).

Fifth, an adhesive cover from the self-adhesive 30, 62 may be removed and the apparatus 10, 40 attached to the saddle 12, 42. The left and right sections are positioned based on the widest point of the saddle 12, 42 and the sit bone width determined. The ischium cradle channels 22, 52 are aligned to be co-axial with the widest point of the saddle and spaced from one another at the same distance as the sit bone width 74 that was previously determined. These points are generally denoted by reference number 76. As shown in FIG. 10, the points are aligned on the saddle 12, 42 such that the left section 68a and the right section 68b are approximately equidistant from a longitudinal center of the saddle 12, 42. The apparatus 10, 40 is then rotated inwardly slightly (as shown by the lower arrows in FIG. 10) so that the outer edge thereof follows the contour of the saddle 12, 42. Finally, the user pushes down on the apparatus 10, 40 to adhere the adhesive 30, 62 to the saddle 12, 42. It will be appreciated that while terms like “first”, “second”, and “third” are used, certain steps may be performed before other ones out of the order described, and these terms are used primarily to delineate between distinct steps in the process.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure. Likewise, directional terms such as front and rear (or back) are used in relation to orientation of the saddle (with a front portion of the saddle being towards a front side of the bicycle).

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A cushioning and support apparatus for providing support to a pelvis of a user, the apparatus comprising:
a main body defining a left section and a right section, the left section and the right section being separable from one another and configured to be selectively positioned on a bicycle saddle, with the left section and the right section each comprising:
an opening in a center portion thereof; and
a plurality of protrusions disposed around the opening and configured to provide support to the pelvis of a user.

2. The apparatus of claim 1, wherein the opening of the left section and the opening of the right section are elongated.

3. The apparatus of claim 1, wherein the main body comprises a cushioning material.

4. The apparatus of claim 1, further comprising an alignment bridge which connects the left section and the right section.

5. The apparatus of claim 4, wherein the left section and the right section are separable at the alignment bridge.

6. A system for providing support to a pelvis of a user, the system comprising:
a bicycle saddle; and
a cushioning and support apparatus comprising:
a main body defining a left section and a right section, the left section and the right section being separated from one another and selectively positioned on a bicycle saddle, with the left section and the right section each comprising:
an opening in a center portion thereof; and
a plurality of protrusions disposed around the opening and configured to provide support to the pelvis of a user.

7. The system of claim 6, wherein the plurality of protrusions of the left section and the right section each comprise an ischium cradle channel, with a center region of each ischium cradle channel being aligned with a widest section of the bicycle saddle.

8. The system of claim 7, wherein each center region is spaced laterally on the bicycle saddle substantially equal to a determined sitting bone width.

9. The system of claim 8, wherein outer edges of the left section and the right section are positioned to generally follow a contour of the bicycle saddle.

10. A method for providing support to a pelvis of the user, the method comprising:
providing a bicycle saddle;
providing a cushioning and support apparatus comprising:
a main body defining a left section and a right section, the left section and the right section, with the left section and the right section each comprising:
an opening in a center portion thereof; and
a plurality of protrusions disposed around the opening and configured to provide support to the pelvis of a user;
identifying a widest section of the bicycle saddle;
identifying a sitting bone width of the user;
separating the left section and the right section; and
positioning the left section and the right section on the bicycle saddle in dependence of the identified widest section and the identified sitting bone width of the user.
